(19) United States
(12) Patent Application Publication
(10) Pub. No.: US 2026/0229752 A1
(43) Pub. Date: Aug. 6, 2026

(54) VENT PLUG FOR AN AUTOMATIC BATTERY WATERING SYSTEM

(71) Applicant: David C. Marconi, Fort Lauderdale, FL (US)

(72) Inventor: David C. Marconi, Fort Lauderdale, FL (US)

(21) Appl. No.: 19/643,183

(22) Filed: Apr. 9, 2026

Related U.S. Application Data
(63) Continuation-in-part of application No. 18/821,600, filed on Aug. 30, 2024.
Application No. 18/821,600 is a division of application No. 18/532,831, filed on Dec. 7, 2023, now Pat. No. 12,080,920.

(51) Int. Cl. H01M 50/618; H01M 50/655; H01M 50/673

(52) U.S. Cl. CPC H01M 50/618; H01M 50/655; H01M 50/673

(57) ABSTRACT

A vent plug for an automatic battery watering system features a passive, vibration-resistant diamond valve assembly that prevents overwatering of lead-acid batteries in industrial vehicles. The vent plug includes a head portion with an inlet for receiving water from a reservoir and a float portion extending into the battery electrolyte. A buoyant float is mechanically coupled to an actuator that selectively engages a spring-biased diamond valve element located in a water chamber. When the electrolyte level drops, the float lowers the actuator, urging the diamond valve element downward to open a precision orifice, allowing metered water flow under hydrostatic pressure. As the electrolyte level rises, the float lifts the actuator, permitting the spring, buoyancy, and hydrostatic forces to reseal the orifice. Monte Carlo analysis confirms near-perfect reliability with negligible weep risk under vibration. The design provides precise, independent fluid replenishment to each battery cell without float valves or active controls, extending battery life while traveling with the battery assembly.

### CROSS REFERENCE

This application is a continuation in part of U.S. application Ser. No. 18/821,600, filed Aug. 30, 2024, which is a divisional of U.S. application Ser. No. 18/532,831, filed Dec. 7, 2023, and issued as U.S. Pat. No. 12,080,920 of Sept. 3, 2024, the entireties of each of which are hereby incorporated by reference.

### FIELD OF THE INVENTION

The present invention relates generally to battery systems that require replenishment of a fluid, and, more particularly, relates to a continuous fluid replenishment system that maintains battery fluid levels while the battery system is in use and while it is being recharged, where the fluid replenishment system travels with the battery and does not rely on float valves or other mechanical operation to provide fluid to the battery.

### BACKGROUND OF THE INVENTION

Although electric vehicles for personal transportation are becoming increasingly popular, industrial vehicles have long been operated by electric battery systems. In particular, many types of fork lift vehicles are battery operated. Unlike electric vehicles made for personal transportation, which use lithium ion-based battery systems, many industrial vehicles use lead acid battery systems. There are a variety of reasons for this, not the least of which is that lead acid battery systems are substantially less expensive than newer battery systems. Industrial operations have an infrastructure based around lead acid battery systems, including charging and maintenance, which would need to be replaced in order to change over to a different battery system, which represents a substantial cost. In addition, it is known that a lithium ion battery system that provides similar energy storage capability as a lead acid battery system will be much lighter than the lead acid battery, and is some applications this is not a benefit. For example, a forklift depends on having a certain amount of weight to counter weight the load it is lifting. As such, lead acid battery systems are likely to persist in certain applications.

Lead acid batteries use aqueous cells and during use they can lose water. Batteries in the center of a battery array, for example, tend to get hotter than batteries on the outside of an array, and lose more water than those on the outside. Since the loss of water can impact the service life of a battery, it is necessary to ensure that the water is replenished before the fluid loss can result in damage to a battery. Typically, replenishment is done when a battery array is removed from a vehicle for charging. A technician will inspect each battery cell and determine if water is needed, and replenish those cells that need replenishing. This is a tedious task that is prone to error.

There have been attempts made to create self-watering battery systems, where a supply of water is provided, and a valve in each battery cell control the flow of water into the battery. In some self-watering systems, the battery cells are connected in a daisy chain where the first battery fluid level controls whether fluid will flow into the subsequently connected battery cells. These systems assume every battery cell in an array will lose the same amount of water, but in high-use systems this is not the case, and as a result, some battery cells will be properly replenished while subsequently connected battery cells continue to lose water because of higher operating temperatures in those particular battery cells.

On the other hand, connecting the higher loss battery cells first in line can result in over-watering of subsequent battery cells. Other systems have sought to use float valves on each battery cell to control fluid flow into each battery cell. However, those systems have been found to be prone to error due to vibration, allowing excess water to flow past the float mechanism. That is, all prior art passive self-watering systems have been unable to successfully regulate the flow of water because the amount of water needed is relatively small, and passive valve systems that, for example, depend on float switches of float valves, are affected by the vibration of the vehicle to such an extent that it overrides the fine metering needed to avoid overwatering. Likewise, gravity and backpressure systems are also overcome by ordinary shock and vibration experienced by batteries on active vehicles. No passive valve system has been designed that has solved the fine metering problem in the presence of ordinary vibration and other mechanical effect resulting from operation of the vehicle in which the batteries are installed.

Therefore, a need exists to overcome the problems with the prior art as discussed above.

### SUMMARY OF THE INVENTION

In one embodiment, the invention provides a vent plug for an automatic battery watering system. The vent plug comprises a body configured to be received within a vent opening of a battery, a water inlet in a head portion of the body, a water chamber fluidly coupled to the water inlet, and a valve opening communicating with the water chamber. A diamond valve element is disposed in the water chamber and is movable between a closed position sealing the valve opening and an open position allowing fluid flow therethrough. A spring biases the diamond valve element toward the closed position. A buoyant float is movably positioned in a lower portion of the vent plug, and an actuator is operatively coupled between the buoyant float and the diamond valve element such that a drop in battery electrolyte level causes the actuator to move the diamond valve element into the open position against the spring bias.

In some embodiments, the diamond valve element comprises a top post extending through the valve opening and a main body having an upper conical portion configured to seat against the valve opening in the closed position.

In further embodiments, the diamond valve element further comprises a lower conical portion, wherein the upper and lower conical portions meet at a maximum diameter larger than an inner diameter of the spring.

In certain embodiments, the spring is preloaded when the diamond valve element is in the closed position.

In some embodiments, the actuator is configured to move the diamond valve element downward by at least 0.5 mm to achieve the open position.

In additional embodiments, the vent plug further comprises a top wall of the water chamber, wherein the valve opening is formed in the top wall and the diamond valve element is biased upward against the top wall by the spring.

In some embodiments, the buoyant float is mechanically linked to the actuator by at least one transfer arm and a transfer bar.

In certain embodiments, the vent plug is configured such that hydrostatic pressure from an elevated water reservoir assists in moving fluid through the valve opening when the diamond valve element is in the open position.

In another embodiment, the invention provides a vibration-resistant valve assembly for a battery watering vent plug. The valve assembly comprises a water chamber having an upper wall with a valve opening, a diamond valve element having a top post extending through the valve opening, and a coil spring disposed within the water chamber and biasing the diamond valve element upward into sealing engagement with the valve opening. An actuator is positioned above the water chamber and is configured to selectively press downward on the top post of the diamond valve element to open the valve.

In some embodiments of the valve assembly, the diamond valve element includes an upper conical sealing surface and a lower conical portion that engages an upper coil of the spring.

In further embodiments, the valve assembly further comprises a buoyant float coupled to the actuator such that downward movement of the float causes the actuator to open the diamond valve element.

In certain embodiments, the spring has a nominal spring rate of approximately 2.23 gram-force per millimeter.

In some embodiments, the valve assembly is configured so that a net closing force remains positive even in the worst-case 5th percentile of production tolerances as determined by Monte Carlo analysis.

In yet another embodiment, the invention provides an automatic battery watering system comprising a water reservoir, a manifold fluidly coupled to the reservoir, and a plurality of vent plugs fluidly coupled to the manifold. Each vent plug is configured for insertion into a respective battery cell vent opening and includes a diamond valve assembly having a spring-biased diamond valve element and a float-actuated mechanism configured to open the valve element only when an electrolyte level in the respective battery cell drops below a predetermined level.

In some embodiments of the automatic battery watering system, each vent plug is configured to travel with the battery during vehicle operation, charging, and storage.

In certain embodiments of the vent plug, the diamond valve assembly is configured to exhibit a probability of non-closing of 0.00% and a probability of significant weep of 0.00% as determined by Monte Carlo simulation of production tolerances.

In further embodiments, the actuator applies an opening force of approximately 4.5 gram-force to the diamond valve element.

In some embodiments, the valve opening is chamfered to match the upper conical portion of the diamond valve element.

In additional embodiments of the automatic battery watering system, the system further comprises an adjustable flow regulator between the water reservoir and the manifold.

In certain embodiments of the vent plug, the buoyant float is disposed in a float portion that extends below the skirt portion into the battery electrolyte when the vent plug is installed.

Although the invention is illustrated and described herein as embodied in an automatic watering system for a battery, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the article being referenced. Those skilled in the art can understand the specific meanings of the above-mentioned terms in the embodiments of the present invention according to the specific circumstances.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 shows an automatic battery watering system, in accordance with some embodiments;

FIG. 2 shows a top plan view of a water manifold for distributing water to batteries in a battery watering system, in accordance with some embodiments;

FIG. 3 is a perspective view of a water manifold with connections to batteries as a use example, in accordance with some embodiments;

FIG. 4 shows an exploded view of a vent plug that is configured to replace a battery vent cap and provide water to the battery, in accordance with some embodiments;

FIG. 5 shows an assembly view of a vent plug, in accordance with some embodiments;

FIG. 6 shows a bottom view of a vent plug insert, in accordance with some embodiments;

FIG. 7 shows a side cut-away view of a vent plug taken along line AA of FIG. 4, in accordance with some embodiments;

FIGS. 8A-8C each show a side cut-away view of the vent plug disposed in a battery as the fluid level in the battery rises, in accordance with some embodiments;

FIG. 9 shows a battery system using an automated battery watering system, in accordance with some embodiments; and

FIG. 10 shows use of an automated battery watering system with a battery of a forklift, in accordance with some embodiments.

FIG. 11 shows an elevational side view of an installed reservoir for use in an automated battery watering system, in accordance with some embodiments of the invention.

FIG. 12 shows a side cut-away view of a vent plug with the section taken centrally along a vertical plane, in accordance with some embodiments.

FIG. 13 shows a side cut-away view of a vent plug with the section taken centrally along a vertical plane, that prevents overwatering of a battery, in accordance with some embodiments.

FIG. 14A shows a side cut-away view of a top portion of a first water chamber having an opening for a valve operation of a vent plug that prevents overwatering, in accordance with some embodiments.

FIG. 14B shows a side cut-away view of a top portion of a first water chamber of FIG. 14A with a diamond valve member having a portion in the opening to close the valve, in accordance with some embodiments.

FIG. 14C shows a side cut-away view of a top portion of a first water chamber of FIG. 14A with an actuator in a closed position, in accordance with some embodiments.

FIG. 14D shows a side cut-away view of a top portion of a first water chamber of FIG. 14A with an actuator in an open position, in accordance with some embodiments.

FIG. 15A shows an elevational side view of a diamond valve member, in accordance with some embodiments.

FIG. 15B shows a perspective view of a diamond valve member, in accordance with some embodiments.

FIG. 15C shows a top plan view of a diamond valve element, in accordance with some embodiments.

FIG. 16 shows a side cut-away view of a diamond valve assembly for a self-watering vent plug that prevents over-watering, in accordance with some embodiments.

FIG. 17A shows a simplified valve assembly for a vent plug with the valve in a closed position, in accordance with some embodiments.

FIG. 17B shows a simplified valve assembly for a vent plug with the valve in an open position, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The invention of the disclosed embodiments provides a novel and efficient automated battery watering system. The inventive watering system is completely passive and avoids the use of float valves. Once the watering system is set up for a given battery assembly, it can travel with the battery assembly and continuously provide water/fluid to the battery while the battery assembly is in use, while it is being charged, and while it is offline being neither used or charged.

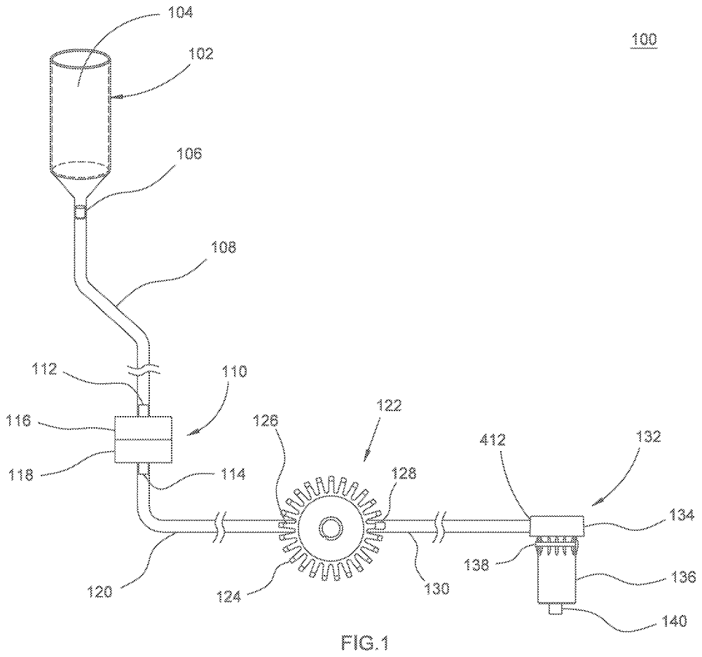

FIG. 1 shows an automatic battery watering system 100, in accordance with some embodiments. The system 100 provides for the watering of one or more aqueous-based batteries, such as, for example, lead-acid batteries used for industrial equipment. As is known, for example, a forklift can be electrically powered using a lead-acid battery assembly, which includes several lead-acid batteries, each having a nominal voltage of about twelve volts. While in use, some of the batteries in the battery assembly will get warmer than surrounding batteries, simply due to their central location in the battery assembly. As a result, these batteries can lose water at a faster rate than batteries on the outside of the battery assembly. Thus, each battery in the battery assembly can have different replenishment requirements to maintain the battery at an optimal operating state.

Accordingly, the system 100 includes a fluid reservoir 102 that has a volume 104. In some embodiments the volume 104 can be on the order of one to two liters. Fluid can be periodically added to the volume 104 as it becomes depleted over time. At the bottom of the reservoir 102 is an outlet 106 that is configured to accept an end of a section of tubing 108. That is, the tubing 108 fits over a short cylindrical structure, the outlet 106, as is well known. There is a channel through the outlet 106 that is fluidly connected to the volume 104 which allows fluid to pass from the volume 104 into the tubing 108.

The section of tubing 108 is connected, at an opposite end, to an inlet 112 of an adjustable flow regulator 110. The flow regulator 110 can be substantially similar to flow regulators used in the intravenous delivery of fluids to a patient in medical applications. There is a fixed portion 118 and a rotating portion 116 that can be rotated to select a flow rate. The flow regulator 110 has an outlet 114 that is connected to a second section of tubing 120, and the flow rate beyond the outlet 114 is constrained by a setting of the flow regulator 110. Being adjustable, the flow rate can be selected by a user/technician based on specific application parameters such as the number of batteries being watered.

The second section of tubing 120 is further connected to a manifold assembly 122 that is shown here on its side. The manifold assembly 122 has an inlet 126 and a plurality of outlets 124. The outlets 124 can be capped or connected to another tubing section such as third tubing section 130, which is connected to an outlet 124 at one end 128 and to a vent plug 132 at the opposite end. The manifold assembly 122 can include a common chamber to which each of a plurality of channels are connected, with each channel passing through a respective one of the outlets 124. Thus, the manifold assembly 122 is responsible for fluid distribution to each of one or more vent plugs 132. The vent plugs 132 each fit into the vent opening over a respective battery. Accordingly, certain portions of the vent plugs 132 are sized to fit into a vent opening of the battery and replace a vent cap that is provided with the battery. Each vent plug 132 can include a head 134, a body 136 includes an outside wall that depends from the head 134, and a retaining ring 138. In general, the body 136 is hollow within the outside wall, and there is a channel that extends from an opening at the inlet 412 to the volume inside the body 136 through the head 134. As will be shown and described in further detail, there is an insert 140 that includes a portion that resides inside the body 136, a portion that closes the bottom of the body 136, and a section that extends below the bottom of the of the body. The retaining ring 138 is a structure that creates an interference fit with the body of the battery in the vent opening so that the vent plug 132 can be inserted into the vent opening and retained therein, but also allow removal of the vent plug 132 from the vent opening. The internal structure of the vent plug 132 assists in regulation of water delivered to a battery in a way that maintain the fluid level of the battery at an optimum and consistent level without the use of floats or other mechanisms.

Thus, water flows from the reservoir 102 to each vent plug 132 as needed. A flow regular and manifold can be connected in line between the reservoir and the vent plug(s). By “in line” it is meant that fluid flows through the flow regulator and manifold from the reservoir to the vent plug(s).

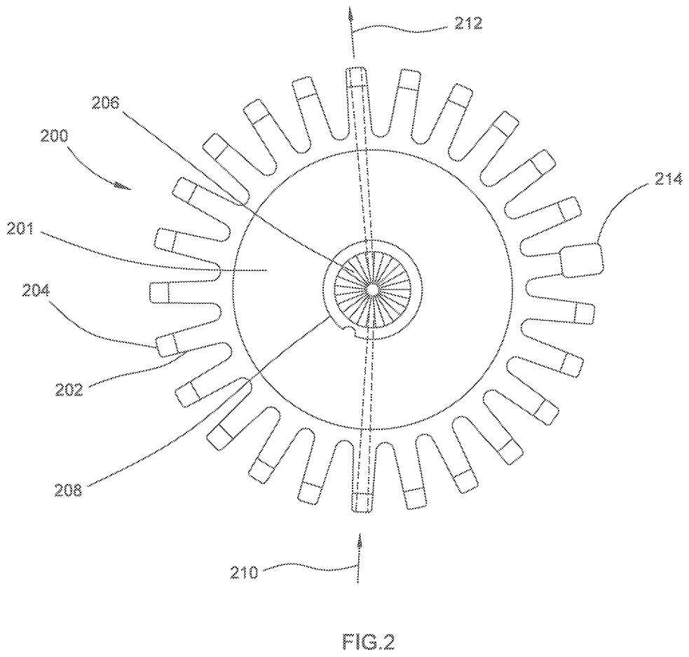

FIG. 2 shows a top plan view of a water manifold 200 as part of a water manifold assembly 122 for distributing water to batteries in a battery watering system, in accordance with some embodiments. The manifold 200 includes a generally planar body 201 that is round or circular and flat/planar. Around the outside of the body 201 are a plurality of outlets 202 that extend radially outward like spokes. Each of the outlets has an outer end or tip 204 that can receive an end of a section of tubing or a cap 214. There is a feed channel or radial channel in each outlet 202 that extends from an opening at the tip 204 to a common chamber 206 that can be centrally located in the body and allows fluid to fill the common chamber 206 and pass through each channel that is open. The channels have an inner end at the common chamber 206 and can be tapered, getting narrower towards the common chamber 206. In some embodiments one of the outlets 202 can be used as an inlet to allow water into the common chamber, as indicated by arrow 210. Water flows out of the outlets 202 in the direction of arrow 212, for example, as needed by each battery, and as regulated by the vent plug in the respective battery. Alternatively, to using one of the outlets 202 as an inlet, the manifold 200 can have an attachment feature 208 that allows connection of an inlet structure that includes a tip to receive an end of a section of tubing like tip 204. The caps 214 fit snugly over the tip 204 of an outlet 202 and form a fluid seal to prevent egress of fluid at the respective outlet 202 on which the cap 214 is attached.

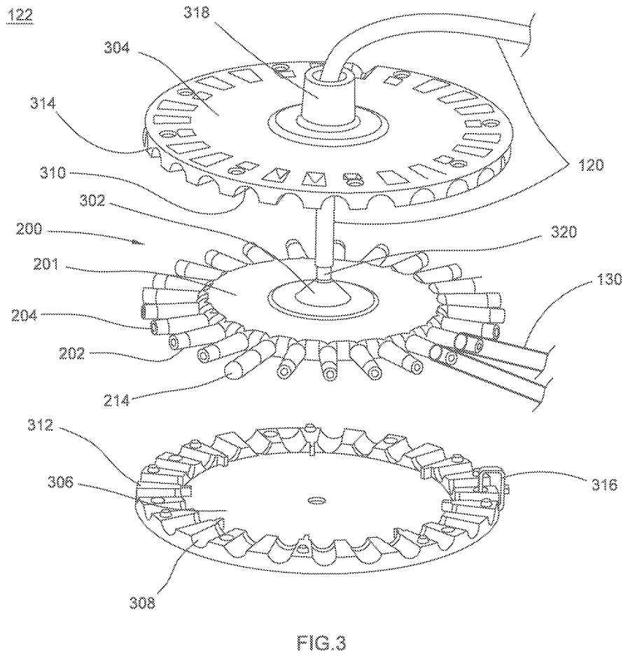

FIG. 3 is a perspective view of a water manifold assembly 122 with connections to batteries as a use example, in accordance with some embodiments. The manifold assembly includes the water manifold 200 with the circular planar body 201 which distributes water radially to each of a plurality of tips 204. For example, a water supply line in the form of tubing section 120 can be connected to a coupler 302 at a central feed point that is attached at the attachment feature 208 to provide water from the tube section 120 to the common chamber 206. One of the outlets 202 can be coupled to tubing section 130, which is further attached to a vent plug 132. Other outlets 202 which are not being used to supply water to a battery vent cap, can be capped using a cap 214.

The manifold assembly 122 can further include a housing comprised of an upper housing portion 304 and a lower housing portion 306. The upper housing portion 304 is disposed over the manifold 200 at a top side of the manifold 200. The top side is the planar side to which the coupler is connected. The lower housing portion 306 is positioned under the manifold 200 opposite the upper housing portion 304. The upper and lower housing portions 304, 306 are likewise circular and planar, and encase the manifold 200, sandwiching the manifold 200 between the upper and lower housing portions 304, 306. Each of the housing portions 304, 306 have a plurality of radially oriented ridges 312, 314 that are separated by semi-cylindrical grooves 308, 310. The grooves 308, 310 are sized to allow the outlets 202 to extends along a cylindrical channel formed by the grooves 310, 312 when the housing portions 304, 306 are brought together, with room to further receive the end of a tubing section that is fit over the outlet 202. The ridges 312, 314 make contact and allow the housing portions 304, 306 to be joined together, such as by welding or by adhesive. Like the grooves 308, 310, the ridges 312, 314 extend to the outer edge in radial direction from the center of the respective housing portion 304, 306. However, they do not extend to the center, leaving room for the body 201 of the manifold 200. In some embodiments there can be openings through the ridge 312, 314 through which a fastener 316, such as a cable tie, screw, bolt, or other fastener can pass to hold the housing portions 304, 306 together, and/or hold the manifold assembly 122 to a mounting location. The upper housing portion 314 can include a feed boss 318 through which the feed tubing section 120 can pass to connect to the manifold 200. The feed boss protects the feed connector 320 that the feed tube 120 is connected to.

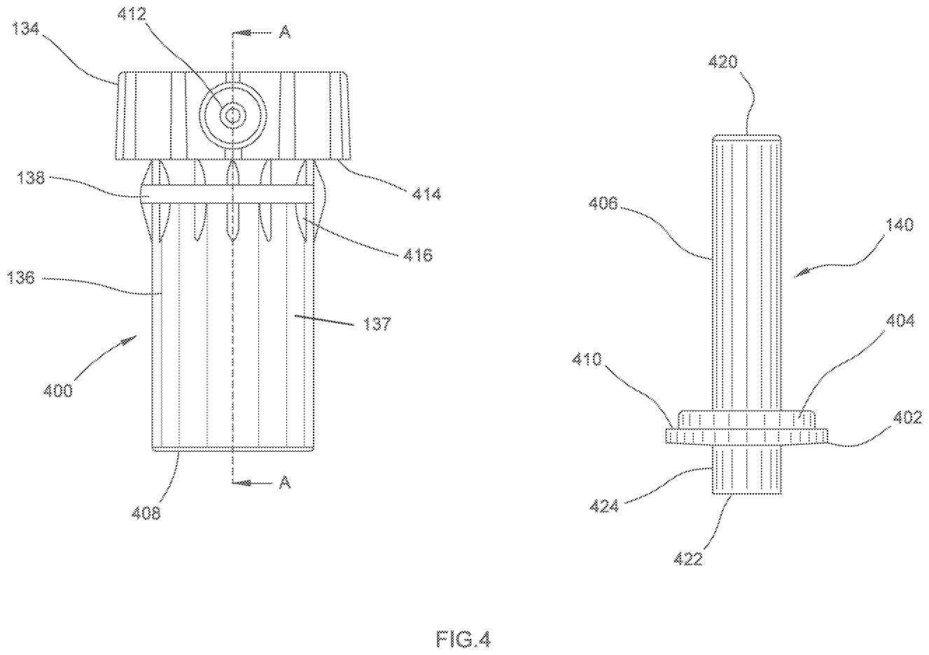

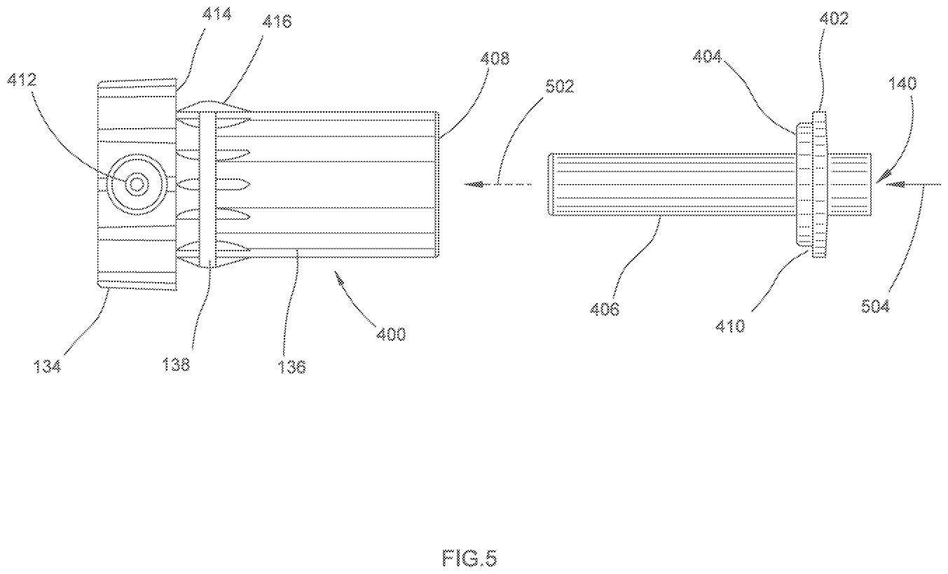

FIG. 4 shows an exploded view of a vent plug that is configured to replace a battery vent cap and provide water to the battery, in accordance with some embodiments. The vent plug 132 is shown formed here in two parts, but any of a number of sub-assemblies could be realized within the spirit and scope of the disclosure. As shown here, the vent plug includes a plug section 400 and an insert section 140 which is inserted into the plug section as shown in FIG. 5. The plug section 400 includes a head 134, a body 136 having an outer wall that extends from a bottom 414 of the head 134. The body 136 has a bottom 408 that is open, and the outer wall that forms the body 136 defines a volume bounded by the outer wall and the bottom 414 of the head 134. The retaining ring 138 can include ramp portions 416 that allow for easier insertion and extraction of the vent plug from a vent opening in a battery. The retaining ring extends outward relative to the outer surface of the outer wall of the body 136. Thus, the body 136 has an outer diameter or size that allows it to pass through a battery vent opening, while the diameter of the retaining ring 138 is such that it comes into contact with the wall of the battery housing around the vent opening and creates friction that resists movement of the vent plug. This friction prevents the vent plug from coming loose or inadvertently coming out of the vent opening, but is not so tight as to prevent manual extraction of the vent plug from the vent opening.

The insert section 140 is intended to be inserted into the body 136 of the plug section 400, and includes a column 406 that is hollow and open at both the top 420 and bottom 422 of the column 406. There is a first annular disk portion 402 that forms a floor of the vent plug 132 around the column 406 that is configured to bear against and seal to the bottom 408 of the body 136. A second annular disk portion 404 is formed above the first annular disk portion 402 and around the column 406. The second annular disk portion does not extend outward from the column 406 as far as the first annular disk portion 404, creating a step 410. The second annular disk portion 404 has an outer diameter that is about the same as the inner diameter of the outer wall of the body 136 of the plug section 400. The column has a lower section 424 that extends below the annular disk portions 402, 404. When the insert section 140 is inserted into the body 136 of the plug section 400, the top 420 of the column 406 is spaced apart from the bottom of the head 134 inside the body 136. As shown in FIG. 5, by arrow 502, the insert section 140 is inserted into the plug section 400 such that a major portion of the column 406 is inside the body 136. The first and second annular disk portions 402, 404 can be thought of as one annular disk portion with a step 410 that allows one portion to be inside the body 136 of the plug section 400.

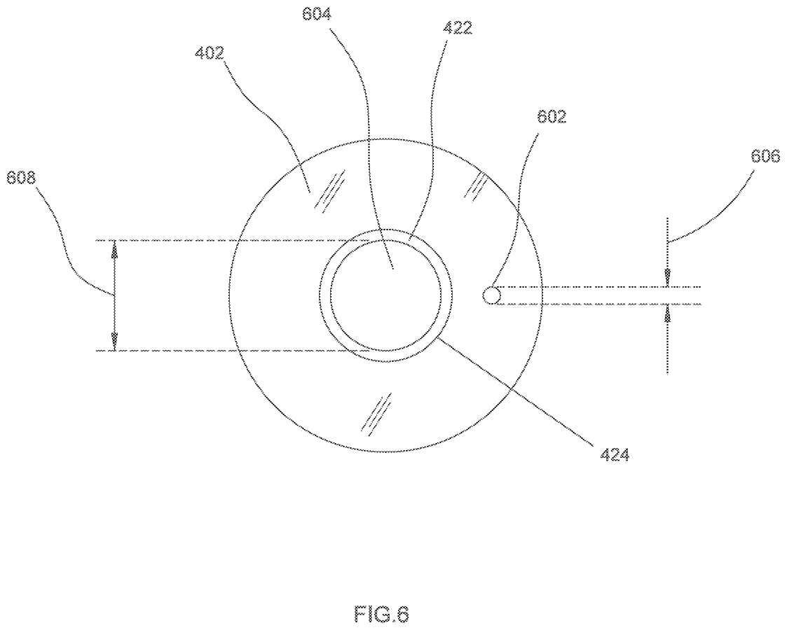

FIG. 6 shows a bottom view of the insert section 140, looking in the direction of arrow 504 of FIG. 5. In view here are the bottom surface of the first annular disk portion 402, and the bottom 422 of the lower section 424 of the column 406. The bottom 422 of the column 406 defines an opening to a channel 604 through the column, which is open at the top as well. The channel 604 has a diameter 608 that can be on the order of 0.1 to 0.5 inches in some embodiments, or larger or smaller in other embodiments. There is also a smaller channel 602 through the annular disk portions that has a diameter of about 0.005 inches with a tolerance of ten percent.

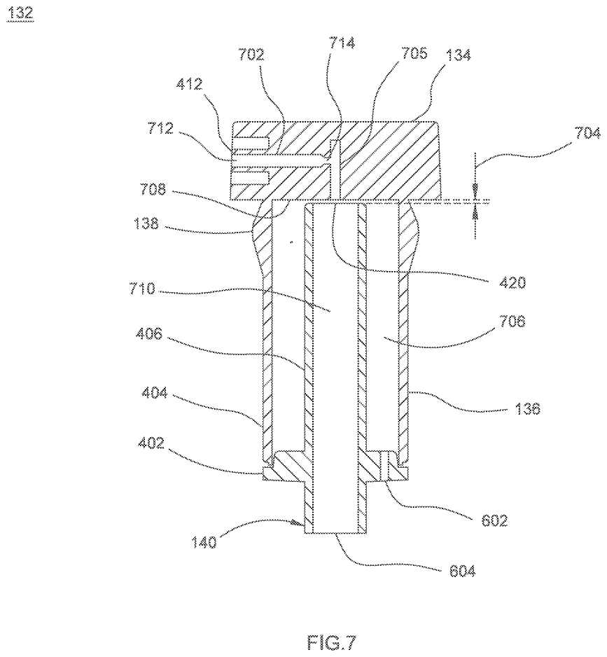

FIG. 7 shows a side cut-away view of a vent plug taken along section line AA of FIG. 4, in accordance with some embodiments. In this view it can be seen that there is a head channel comprised of a first channel 702 that leads from an opening 712 at the inlet 412 to a second channel 705 that has an exit that is an opening at the bottom 708 of head 134 inside the body 136. The opening of the second channel 705 at the bottom 708 of the head 134 is positioned over the opening at the top 420 of the column 406 of the insert section 140. There is a pinhole opening 714 from the first channel 702 to the second channel 705 which provides an obstruction that helps inhibit the flow of fluid in the presence of back pressure in the vent plug. Water passing through the first channel 702 to the second channel can into the channel 604 of the column 406 and into the fluid in the battery (assuming the vent plug is in a vent opening) in the absence of back pressure. There is a gap 704 between the top 420 of the column and the bottom 708 of the head in the body 136. The gap 704 can be on the order of 0.01 inches. As can be seen, there is an internal chamber or volume 706 around the column 406 inside the body 136, and there is a column chamber or column volume or column channel 710 inside the column 406 of the channel 604. These two volumes 706, 710 are connected through the gap 704. The chambers 706, 710 are volumes that are largely with air, except for the wall of column 406.

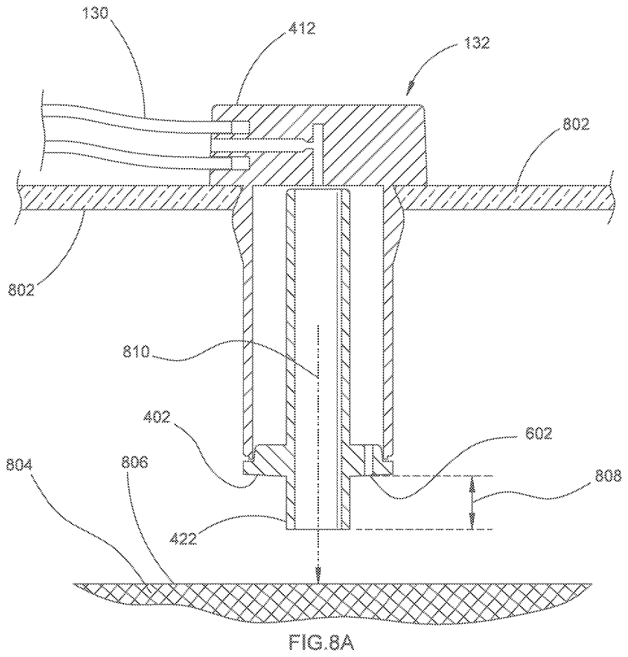

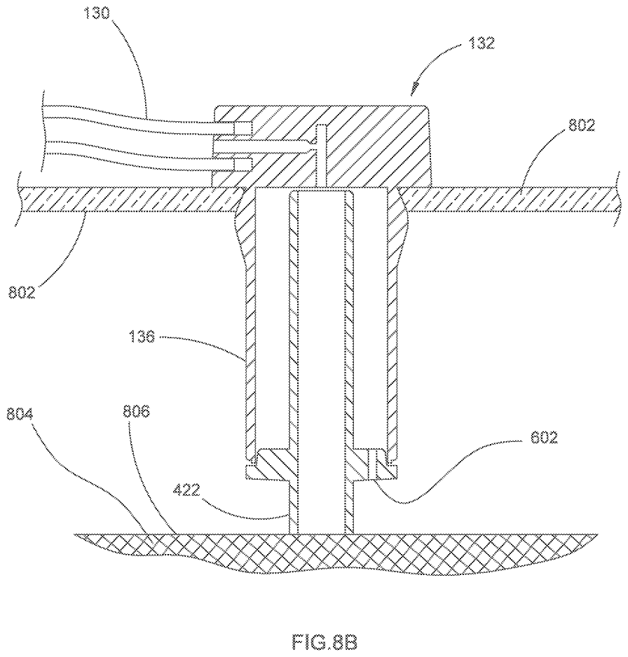

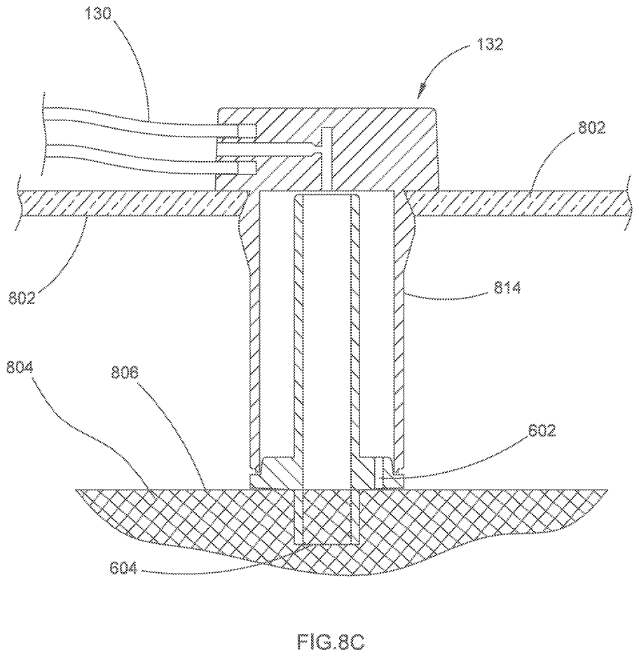

FIGS. 8A-8C each show a side cut-away view of a vent plug disposed in a battery as the fluid level in the battery rises, in accordance with some embodiments. In each of FIGS. 8A-8C there is a battery housing 802 which is the top of the battery. The vent plug 132 is positioned in a vent opening through the housing 802. There is a tubing section 130 connected to the inlet 412 to deliver water to the vent plug 132 from the manifold assembly 122. Inside the battery is a fluid 804 which can be the electrolyte that allows electrical flow between the plates of the battery. The fluid has a surface 806 which indicates the fluid level in the battery. In FIG. 8A, the fluid level is below the bottom 422 of the column of the insert portion, resulting in no back pressure inside the vent plug 132. As a result, water freely flows into the battery as indicated by arrow 810. It is also shown there that there is a height 808 at which the bottom of channel 602 is above the bottom 422 of the column. In FIG. 8B enough water has been provided to the fluid 804 to cause the fluid level to rise to the bottom 422 of the column. As a result, air or other gases inside the volume of the body 136 can escape through channel 602, but not at the bottom 422 of the column. At this point, the water flow through the plug slows down due to increased back pressure. In order for water to flow into the vent cap 132, it must displace air inside the vent plug 132. That is, air and gasses inside the body 136 must be pushed out of the body 136 in order for water to flow into the vent plug 132. In FIGS. 8A and 8B gasses can escape freely in FIG. 8A out through the bottom of the channel 604, and in FIG. 8B through channel 602. As a result, there is a lack of backpressure in the internal volume of the vent plug, and fluid can flow into the vent plug.

In FIG. 8C the fluid level has risen to cover the bottom of the channel 602, and thus there is nowhere for air/gas to escape, resulting in backpressure that inhibits water flowing through the vent plug. At this point water flowing into the vent plug stops and the fluid level of the battery fluid 804 is at an optimum level. Accordingly, the dimensions of the vent plug are such that the bottom of channel 602 is positioned at the height of the optimum fluid level for the battery. In experiments conducted using the dimensions of the channels 702, 602, the diameter of the tubing, the height of the reservoir over the battery, and the flow rate selected at the flow regulator were found such that the fluid levels of several batteries could be maintained independent of each other at optimum levels. Minimizing the inside diameter of the tubing used in the system prevents the collection of a mass of water in the tubing that can create a forward pressure that overcomes the back pressure created by channels 602, 602 being closed off by fluid in the battery. The tubing can have a nominal inner diameter of 0.125 inches in the sections shown herein. Other size tubing can be used, however, based on the application. It will be appreciated that the internal volume of the vent plug is sealed so that air/gasses can only escape through the bottom 604 of the extension of the insert, and through the opening 602. Once those are covered by the battery fluid level there is no way for air/gas inside the vent plug to escape, which creates back pressure that inhibits further water from entering the vent plug through the tubing.

FIG. 9 shows a battery assembly 900 using an automated battery watering system, in accordance with some embodiments. There is a reservoir 102 that is fluidically coupled to a flow regulator 110 through a first section of tubing 120. The flow regulator 110 is fluidically coupled to a manifold assembly 122 by a second section of tubing 130. The call-out 908 shows the flow regulator 110 in more detail. There are nine batteries 902 shown, each battery having electrodes 904, 906. A vent plug 132 is shown inserted into the vent opening of each battery, and each vent plug 132 is fluidically coupled to the manifold through a section of tubing 130. The nine batteries 902 form the battery assembly 900 which can be used to power, for example, a forklift.

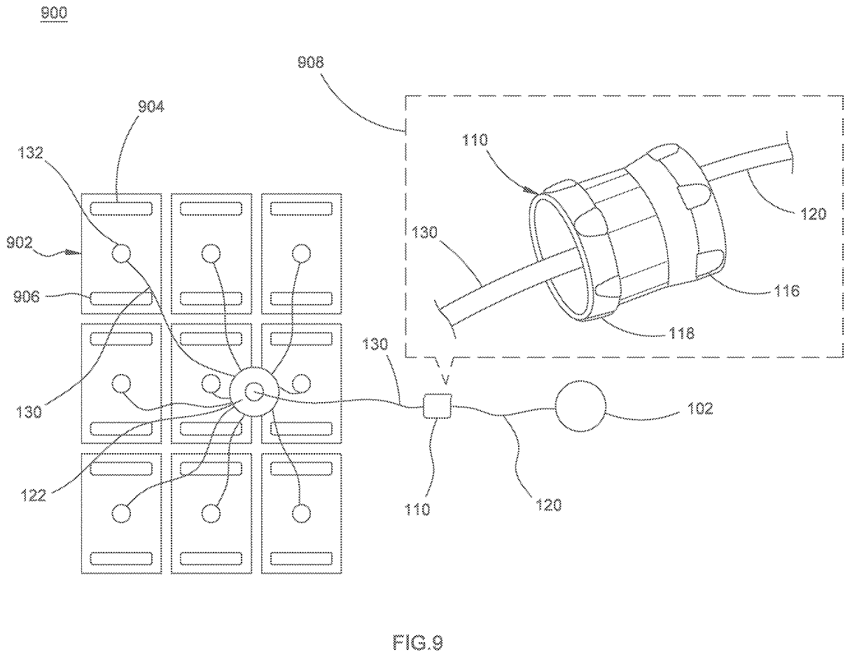

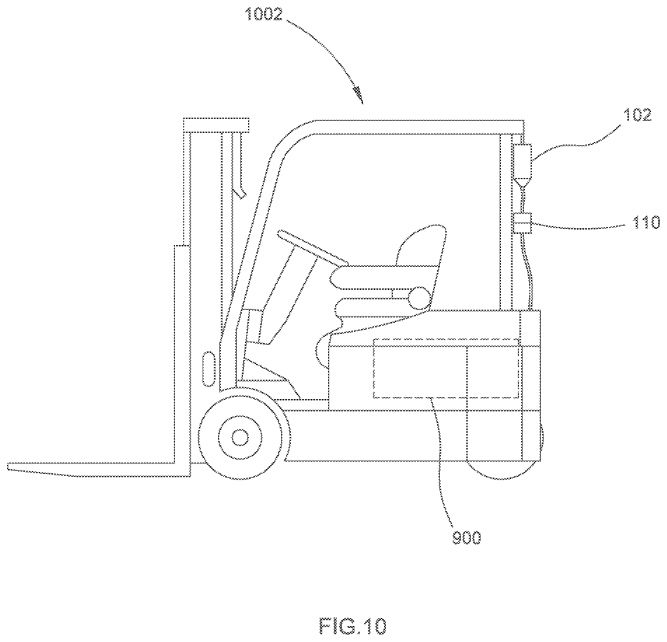

FIG. 10 show use 1000 of an automated battery watering system with a battery assembly 900 of a forklift 1002, in accordance with some embodiments. The forklift 1002 includes a space where the battery assembly 900 is housed and connected to the controls and motors of the forklift 1002. A reservoir 102 can be hung on the forklift above the flow regulator 110, and both of which are above the battery assembly 900. The battery assembly 900 can be removed from the forklift for charging, and a different battery assembly can be placed in the forklift for continued operation of the forklift. When the battery assembly is removed, the reservoir 102, flow regulator 110, tubing, and manifold all travel with the battery assembly, and maintain the fluid levels of each battery in the battery assembly while the battery assembly is being charged, as well as when the battery assembly is finished charging and in queue to be placed into another forklift.

FIG. 11 shows an elevational side view of an installed reservoir 1102 for use in an automated battery watering system 1100, in accordance with some embodiments of the invention. The reservoir 1102 is shown mounted on a steel pillar 1104, such as a pillar of a forklift around the operator's compartment. A pair of straps 1106 can pass round the pillar 1104 and the reservoir 1102, through loops 1108 on the side of the reservoir 1102, to hold the reservoir 1102 in place. Further, the reservoir 1102 can includes magnet holder 1116 that holds one or more magnets 1118 that are fixed to the magnet holder 1116. The magnets 1118 can produce a magnetic attractive force to the pillar 1104 that is strong enough to hold the reservoir 1102 in place and the straps 1106 are used to ensure the reservoir 1102 stays in place on the pillar 1104 in the event of an inadvertent impact or such.

The reservoir 1102 has an internal volume for holding a volume of fluid that is dispensed to batteries in order to keep the fluid level of the batteries at an optimum operating level. A top 1110 of the reservoir 1102 can be threaded to receive a cap 1114 to contain the fluid in the reservoir 1102 and to allow for periodic replenishment of the fluid. At the bottom of the reservoir 1102 there is a stem 1120 that extends downward and houses a flow regulator than can replace an in-line flow regulator such as flow regulator 110. There is a channel through the stem 1120 that is fluidly coupled to the volume of the reservoir 1102. A regulation chamber 1130 is formed in the stem 1120 in correspondence with a boss 1122 which extends horizontally. The boss 1122 is configured to receive and hold a regulator valve 1124 which threads into the boss 1122. Once positioned in the boss 1122, the valve 1124 can be turned to a desired position to adjust the flow of fluid through the stem 1120 to a tube 1136, which fits over outlet 1138, that is coupled to a distribution manifold assembly (e.g., 122). The valve 1124 has a tapered portion 1128 coupled to a threaded shaft 1126. The threads on the threaded shaft fit into thread on the inside of the boss 1122. A knob 1134 assists in turning the valve 1124 to the desired position. The tapered portion is separated from the threaded shaft 1126 by a seal 1132. The regulation chamber 1130 can have a shape that is the same as the tapered portion 1128. If the valve 1124 is turned to fully insert the threaded portion 1128 into the regulation chamber, then the threaded portion will contact the wall of the regulation chamber 1130 and prevent the flow of fluid into the tube 1136. By turning the knob 1134 to back the tapered portion 1128 out from the regulation chamber 1130 there is increasing space, and hence increasing flow of fluid past the tapered portion 1128 from the reservoir 1102 into the tube 1136.

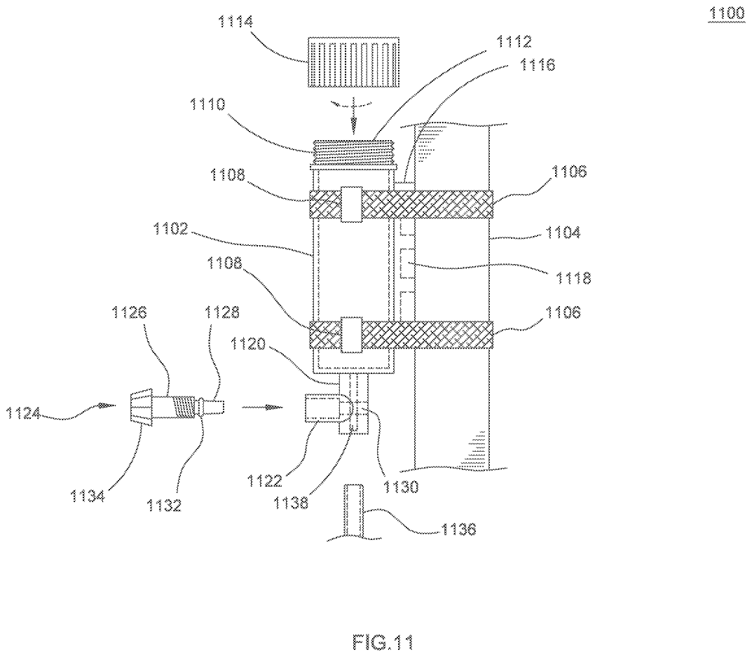

FIG. 12 shows a side cut-away view of a vent plug 1200, with the section view taken centrally along a vertical plane, in accordance with some embodiments. The vent plug 1200 is similar to that of FIGS. 7-8C but includes in internal stem 1216 that extends downward from the head 1202 inside the volume 1224 inside the outer wall 1222. The stem 1216 fits inside the internal space 1220 of the column 1212 of the insert. There is a small gap on the order of thousands of an inch (e.g., 0.001″-0.010″+/−50%) between the inner surface of the column 1218 and the outer surface of the stem 1216. This allows air to pass between the stem 1216 and the column 1218.

In the head 1202 there is an inlet 1204 configured to receive the end of tubing section 1206 through which water is provided to the vent plug 1200 from the manifold. A horizontal channel 1208 in the inlet section connects to a vertical channel 1210 that continues from the head portion to the stem 1216. The horizontal channel narrows to an opening 1214 between the horizontal channel 1208 and the vertical channel 1210. The opening 1214 can have a diameter on the order of 0.010 inches with a tolerance of ten percent in some embodiments, although the opening 1214 can be larger or smaller. At the bottom of the insert is a floor 1226 that meets the bottom of the outer wall 1222, and which can be joined to the bottom of the outer wall such as by welding. An opening 1228 passes though the floor 1226 (which is an annular disk portion). The opening 1228 can have a diameter of about 0.005 inches, with a tolerance of ten percent. An extension 1230 of the insert extends down from the floor 1226.

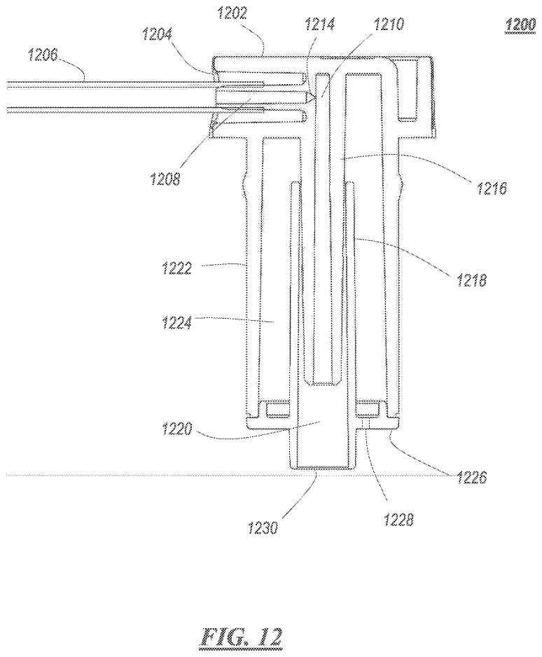

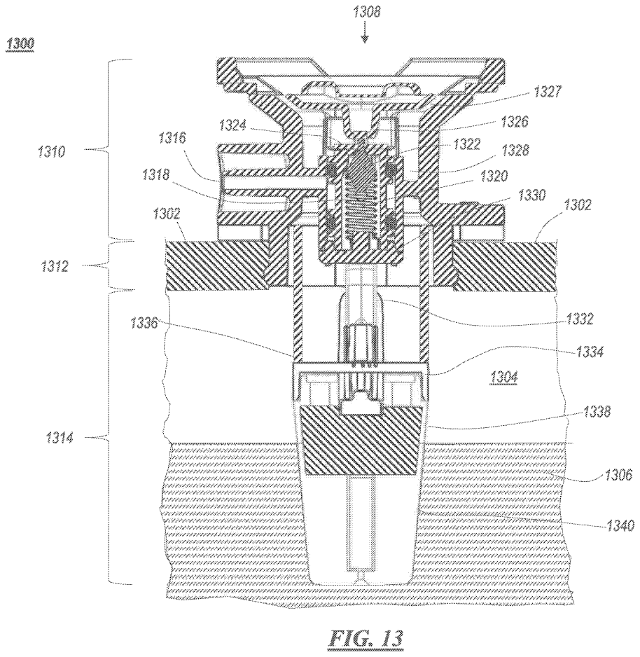

FIG. 13 shows a side cut-away view of a vent plug 1300 with the section taken centrally along a vertical plane, that prevents overwatering of a battery, in accordance with some embodiments. The vent plug 1300 includes a valve assembly that prevents over-watering that can occur due to the vibrations and other mechanical shock to the watering system that occur as a result of being mounted on an active vehicle (e.g. a forklift). The vent plug 1300 is configured to be inserted into a battery cover 1302, and can include detent features for retaining the vent plug 1300 in an opening through the battery cover 1302. Inside the battery there is a small region 1304 of air and gas above the aqueous electrolyte 1306. The vent plug in inserted into the opening (a vent) of the battery cover 1302 as indicated by arrow 1308. The vent plug 1300 includes head portion 1310 that remains above and external to the battery. The vent plug 1300 further includes a skirt portion 1312 that is configured to be inserted into the vent opening of the battery cover 1302 and includes mechanical features that mechanically interact with corresponding mechanical features of the battery cover 1302 to retain the vent plug in the vent opening, in the same what that a vent cover inserted into the vent opening would be retained in the vent opening. The vent plug also has a float portion 1314 that extends into the battery below the battery cover 1302 and is intended to have a buoyant member in the aqueous battery electrolyte 1306. The float portion 1314 can include a wet portion 1340 that is in the electrolyte 1306, and a dry portion 1338 that is above the electrolyte 1306. The buoyant member includes a top 1334 that meets with one or more control arms 1336. A guide 1332 is provided to keep the buoyant member centered under the vent opening. The vent plug 1300 incudes a small chamber 1318 in which there is a spring 1320. The spring 1320 is anchored at its bottom end to the bottom 1330 of the chamber. At the top end of the spring there sits a diamond valve element 1322, which is sized to partially fit into the coils of the spring 1320 at the top end of the spring 1320. Water is provided through an inlet 1316 to the chamber 1318. A top wall 1324 of the chamber 1318 includes an opening through which a top post of the diamond valve element 1322 sits. Above the chamber 1318 is an actuator element 1327 that is coupled to the control arms 1336. The actuator 1327 includes an interface 1326 that can bear against the top of the top post of the diamond valve element 1322.

Under normal conditions, when the level of the battery electrolyte 1306 is high enough, the top 1334 of the float will push up against the control arms 1336, which raise up the actuator 1327 and its interface 1326, removing downward pressure from the top post of the diamond valve element 1322. As a result, the bias of the spring 1320, along with the buoyancy of the diamond valve element 1322, act to urge the diamond valve element 1322 upwards against the top wall 1324 of the chamber and thereby sealing the opening. When the level of the electrolyte 1306 drops, however, then the float follows the level of the electrolyte 1306, allowing the control arms 1336 and the actuator 1327 to drop as well, putting pressure on the top post of the diamond valve element 1322. As a result, when the actuator urges the diamond valve element 1322 downward, a small gap is provided in the opening of the top wall 1324 that allows water to escape from the chamber 1318 through the opening of the top wall 1324. Since the water source (e.g. reservoir 1102) is elevated above the vent plug 1300. Accordingly, hydrostatic pressure moves the water from the chamber 1318 through the opening in the top wall 1324 when the actuator 1327 bears down on the top post of the diamond valve element 1322, allowing water to trickle out, and down space 1328 through the skirt portion 1312 and into the electrolyte 1306.

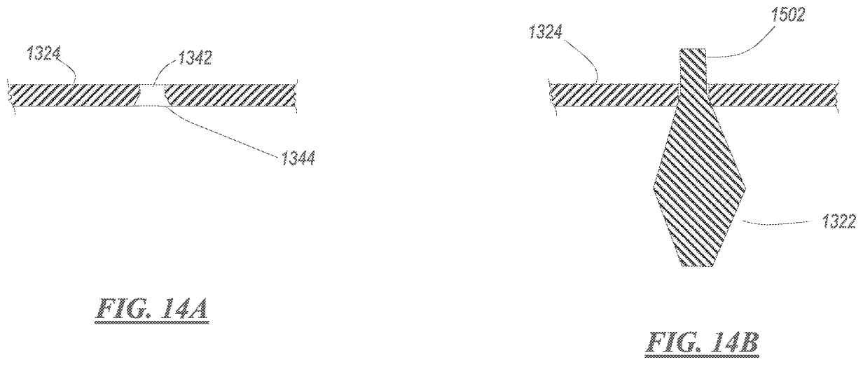

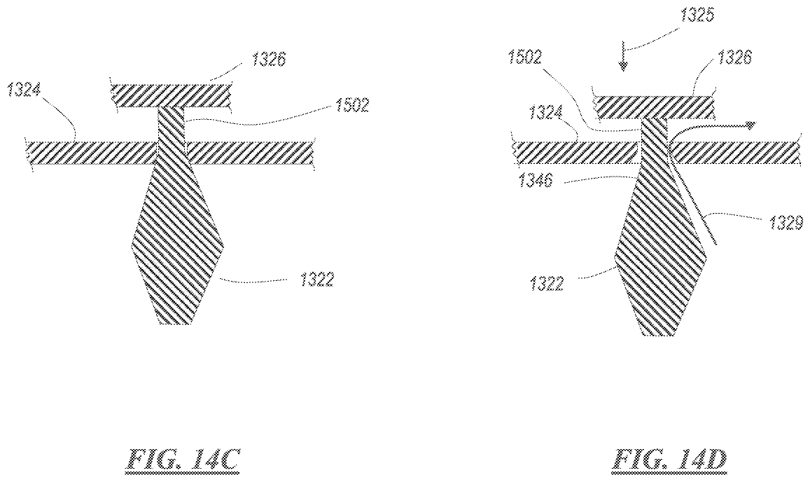

FIG. 14A shows a side cut-away view of a top portion 1324 of a first water chamber having an opening 1342 for a valve operation of a vent plug that prevents overwatering, in accordance with some embodiments. FIGS. 14B-D are to also be referenced in the following discussion; these drawings show selected portions of the valve assembly in isolation to more clearly show the components being discussed and how they interoperate. The opening 1342 is sized to receive the top post of the diamond valve element 1322 therein, and can be chamfered at the bottom of the opening at an angle that matches an angle of the top portion of the diamond valve element 1322 so that the buoyancy force of the diamond valve element 1322 in the water, along with the bias force of the spring 1320 create a seal of the opening 1342 when there is insufficient downward force on the top post 1502 of the diamond valve element 1322 from the interface 1326 of the actuator 1327, as in FIG. 14B. FIGS. 14C and 14D show the interface 1326 of the actuator 1327. In FIG. 14C the actuator 1327 is being lifted through the buoyancy force of the float against the control arms 1336, which lifts the actuator 1327 and removes force against the top post 1502, which extends through the opening 1342 above the top wall 1324. In FIG. 14D a situation where the level of the electrolyte has dropped is shown, necessitating replacement water. As a result of the level of the electrolyte dropping, the float has also dropped with the electrolyte, causing the actuator 1327 to likewise drop as indicated by arrow 1325, and the interface 1326 then bears down on top post 1502, moving the diamond valve element 1322 downward. As a result, a small gap is created in the opening 1342 which allows water, under hydrostatic pressure, to move through the opening 1342, as indicated by arrow 1329.

Unlike conventional float valves, the buoyancy and the mass of the diamond valve element 1322, along with the spring rate of the spring 1320, the opening 1342 size, the mass of the actuator 1327, and the height of the water reservoir are carefully selected to balance proper valve operation while at the same time preventing inadvertent valve opening due to vibration and mechanical shock experienced by the valve assembly and the vent plug by virtue of being installed on a battery of an active vehicle. Without the spring 1320, for example, it was found that the valve assembly would open occasionally due to vibration, resulting in overwatering of the battery. Some specific dimensions are given hereinbelow as an example, but routine experimentation can be used to find ideal dimensions for various specific applications. Applicant has conducted a Monte Carlo analysis of these various dimensions to select one optimum set of dimensions that has been found to achieve the desired self-watering action, without over-watering occurring in actual use, using only passive elements.

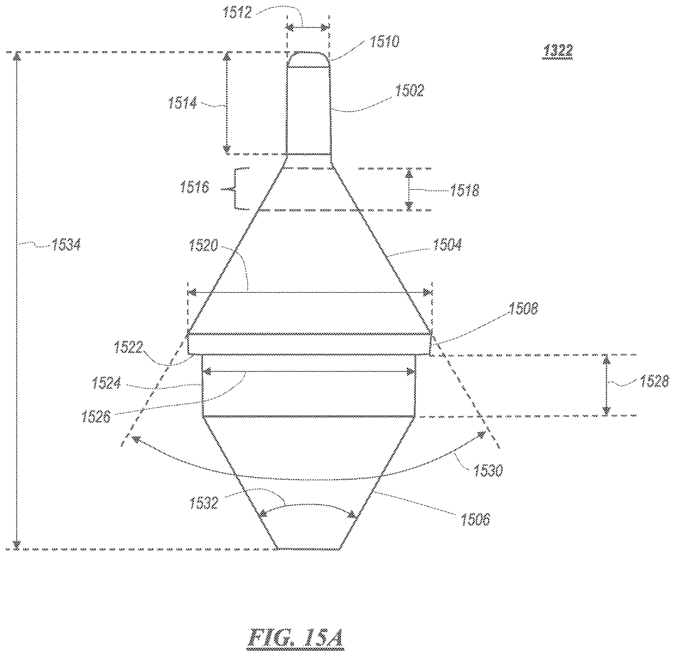

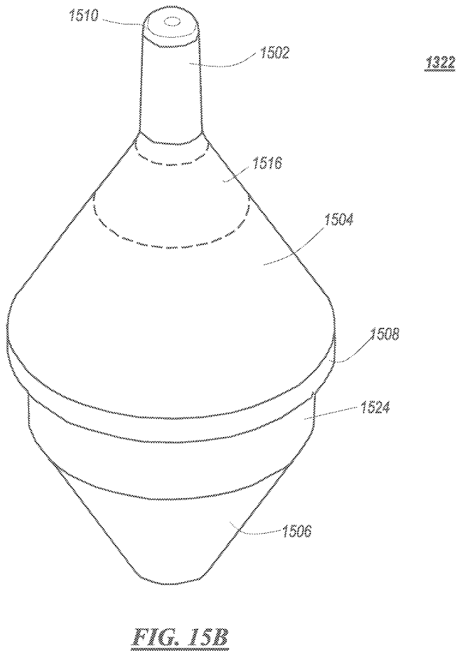

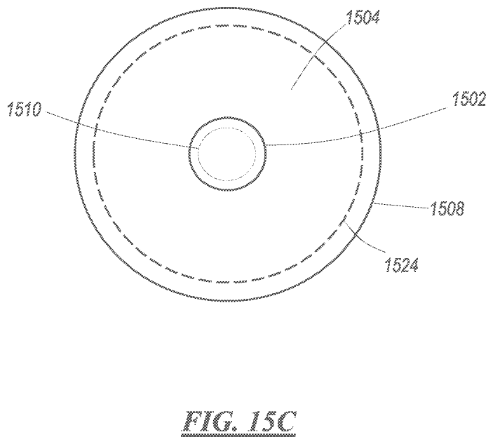

FIG. 15A shows an elevational side view of a diamond valve element 1322, FIG. 15B show a top and side perspective view of the diamond valve element 1322, and FIG. 15C shows a top plan view of the diamond valve element 1322, in accordance with some embodiments. The diamond valve element 1322 has a roughly diamond-shaped profile, when viewed from the side, and is circular when viewed from the top. Likewise, the top post 1502 is generally cylindrical, and meets the main body of diamond valve element 1322 at a shoulder formed by upper conic portion 1504. The top post 1502 has a length 1514 that is long enough to extend through the top wall of the chamber and meet the interface of the actuator. In some embodiments the length 1514 can be about 1.7-1.75 millimeters. The top post 1502 can have a diameter 1512 of about 0.7-0.75 millimeters. The top 1510 of the top post 1502 can have a rounded profile to facilitate fitting into the opening in the top wall of the chamber. At the top part of the upper conic portion 1504 there is a sealing region 1516, which has a vertical height 1518 of about 0.85-0.95 millimeters. This region 1516 fits into the chamfered opening in the top wall to seal the opening when the actuator is not bearing downwardly on the top post 1502, although it is also contemplated that the shoulder region will seal an unchamfered opening as well. The upper conic portion extends downward to a midband 1508, which is the widest (largest diameter) of the diamond valve element 1322. The angle 1530 of the upper conic portion can be about sixty degrees in some embodiments. The midband 1508 is a short, flat, vertical portion having a diameter 1520 of about 4.0-4.1 millimeters. Under the midband region 1508 is a cylindrical waist portion 1524. The waist portion 1524 has a smaller diameter 1526 of about 3.58-3.63 millimeters, thereby forming a shoulder 1522 at a right angle to the vertical side of the waist portion 1524. The waist portion 1524 can have a height 1528 of about 1.0-1.1 millimeters. The waist portion 1524 is configured to fit within the coils of the biasing spring 1320. Below the waist portion 1524 is the lower conic portion 1506, which has an inverse taper relative to the upper conic portion 1504. Like the upper conic portion 1504, the lower conic portion also has a taper angle 1532 of about sixty degrees. Overall, the height 1534 of the diamond valve element 1322, from the top of the top post 1502 to the bottom of the lower conic portion 1506, is about 8.0-8.6 millimeters. In the above discussion of the dimensions of the diamond valve element 1322, there are expected tolerances by which the various dimension can vary without undermining the function and utility of the diamond valve element, depending on the particular application. A range of +/−5% as a tolerance for those dimensions should be assumed unless otherwise stated.

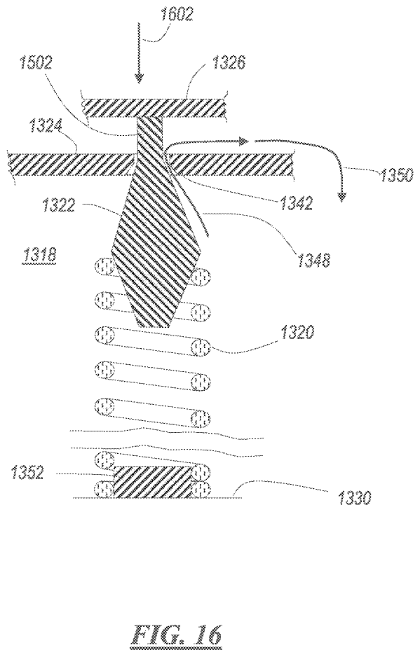

FIG. 16 shows a side cut-away view of a diamond valve assembly for a self-watering vent plug that prevents over-watering, in accordance with some embodiments. Similar to FIG. 14D, the valve system is shown in an open state, meaning it is letting water through the opening 1342. Here the spring 1320 is also shown, and the diamond valve element 1322 is shown seated into the coils of the spring 1320 at the top end of the spring 1320. The conic shape of the lower portion (e.g. 1506) fits into the axial center of the coils of the spring 1320, but the midpoint 1508 of the diamond valve element 1322 has a diameter that is larger than the inner diameter of the coils of the spring 1320. As a result, the top coil of the spring 1322 is in contact with the lower portion 1506 of the main body of the diamond valve element 1322. In FIG. 14C, when the valve is closed, the spring is exerting force against the diamond valve element 1322. That is, in the closed position, the spring 1320 is already preloaded (compressed) relative to its free state. The chamber 1318 is filled with water, thus there is also hydrostatic force and buoyancy force acting on the diamond valve element 1322. The spring 1320 is anchored at its bottom end to an anchor structure 1352, which is a protrusion of material of the bottom 1330 of the chamber 1318. As shown, the actuator interface 1326 is moved down, as indicated by arrow 1602. The weight of the actuator overcomes the forces urging the diamond valve element 1322 upwards, thereby moving the diamond valve element 1322 downwards. The amount of movement can be small, on the order of half a millimeter (0.5 mm). Once opened, hydrostatic force moves water from the chamber 1318 through the opening 1342, as indicated by arrows 1348, 1350. The water is then channeled or otherwise directed to fall into the battery. Once enough water falls into the battery through the vent plug, the float will rise enough to relieve the weight of the actuator on the top post 1502 of the diamond valve element 1322, resulting the opening 1342 being closed again by the diamond valve element 1322 due to the spring force, buoyancy force, and hydrostatic force acting on the diamond valve element 1322.

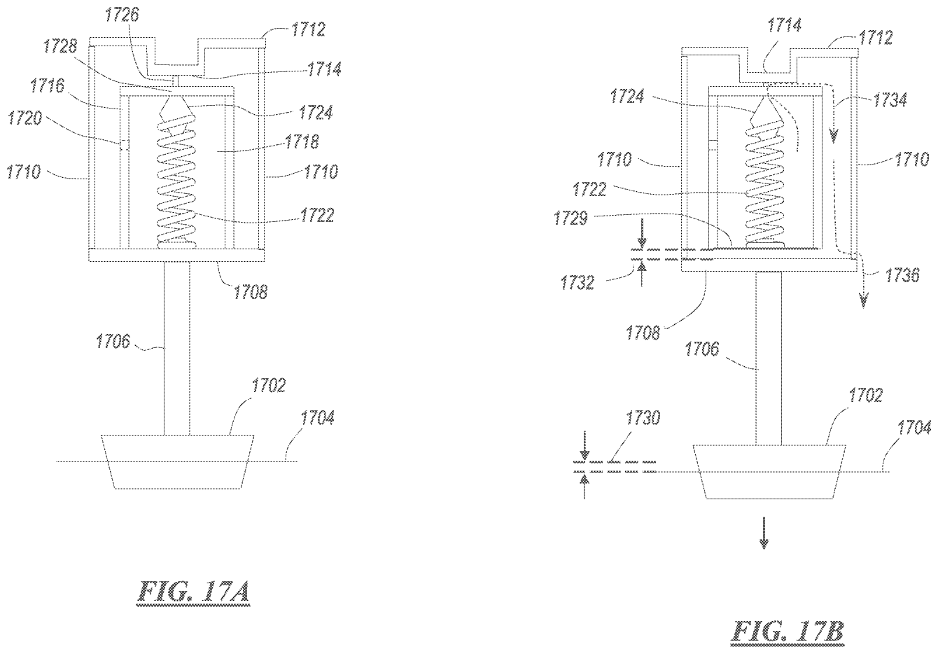

FIGS. 17A and 17B show a simplified valve assembly for a vent plug with the valve in a closed position 1700A and an open position 1700B, respectively, in accordance with some embodiments. The valve assembly is used in a vent plug as shown, for example, in FIG. 13. In general, the assembly includes a float 1702 which is disposed internal to the battery when the vent plug is properly seated in a vent opening. The float 1702 sits in the aqueous electrolyte 1704, and is buoyant in the electrolyte 1704. As a result, the float 1702 moves with the level of the electrolyte 1704. If water evaporates out of the electrolyte 1704, the level of the electrolyte 1704 and the float 1702 will drop. When water is added to the electrolyte 1704 through the valve assembly the level of the electrolyte and the float 1702 will increase accordingly. The float 1702 is connected to the lower end of a guide 1706 which is a post that moves with the float 1702. The upper end of the guide is connected to a transfer bar 1708, which is further connected to one or more transfer arms 1710. The transfer bar 1708 is a horizontally elongated member and the transfer arms 1710 are vertically elongated members. The transfer arms 1710 are further connected to an actuator 1712. The actuator, transfer arms 1710, transfer bar 1708, and guide 1706 all move with the float 1702 up and down in the vertical direction.

The actuator 1712 sits over a chamber made up of side walls 1716, top wall 1728 and bottom 1729. There is an opening 1720 through one of the sidewall 1716 through which water enters the volume 1718 of the chamber. Within the chamber there is a spring 1722 that is a coil spring oriented so that axis is vertical. The bottom end of the spring 1722 as coupled to an anchor feature at the bottom internal surface of the chamber, and there is a diamond valve element 1724 disposed in the top end of the spring 1722. The diamond valve element has a top post that fits through an opening in the top wall 1728 of the chamber. The top end of the top post is positioned proximate to the interface 1714 of the actuator 1712. The interface 1714 is the portion of the actuator 1712 that is configured to bear against the top post of the diamond valve element 1724 to open the valve. The spring 1722 has a length such that, when positioned in the chamber with diamond valve element 1724 in the closed position, the spring is slightly compressed. By the closed position it is meant that water does not move through the opening in the top wall 1728 because the diamond valve element 1724 is sealing the opening closed as a result of the forces acting on the diamond valve element 1724, including the spring, hydrostatic force of the water, and the buoyancy of the diamond valve element 1724 in the water that has filled the volume 1718 of the chamber.

In FIG. 17B, the level of the electrolyte 1704 has dropped by an amount 1730. This can be a very small distance, on the order of half a millimeter. As a result, the float 1702, guide 1706, transfer bar 1708, transfer arms 1710, and actuator 1712 all also drop correspondingly as indicated by gap 1732. This causes the interface 1714 to bear downwardly against the top post of the diamond valve element 1724, thereby moving the diamond valve element 1724 downward, resulting in space being created in the opening through the top wall 1728 through which the top post of the diamond valve element 1724 communicates. Once the diamond valve element 1724 has moved enough, water, under hydrostatic pressure as a result of the water reservoir being mounted higher up than the vent plug, forces water through the opening, as indicated by arrows 1734, 1736 falling into the electrolyte 1704 below, thereby replenishing the water lost through evaporation. Once enough water is added, the float 1702 will rise sufficiently to lift the actuator 1712 through the guide 1706, transfer bar 1708, and transfer arms 1710 to relieve pressure against the top post of the diamond valve element 1724, allowing the diamond valve element 1724 to again seal off the opening though the top wall 1728.

To validate the robustness of the diamond valve assembly to manufacturing tolerances and to confirm reliable passive operation of the self-watering vent plug in the presence of vehicle vibration and mechanical shock, a Monte Carlo simulation comprising over 100,000 iterations was performed. In each iteration, realistic production tolerances were randomly sampled using uniform distributions for conservatism. Key design parameters included a nominal spring rate of 2.23 gram-force per millimeter (gf/mm) (±15%), a nominal free length of 11.7 mm (±0.30 mm), a nominal stack height of 10.80 mm (±0.12 mm), a nominal preload of 0.90 mm, a hydrostatic assist to closing of +0.60 gf, a friction allowance of 0.50 gf, and an actuator force of 4.5 gf downward. The simulation evaluated critical performance metrics such as preload, net closing force, breakaway force, opening travel, and leak potential under 30 inches of head pressure.

The Monte Carlo results demonstrated statistically near-perfect reliability across the simulated population. Failure probabilities for all critical modes were zero or negligible: non-closing (net closing force≤0 gf) at 0.00%, marginal seal/high weep risk (net closing <0.5 gf or <1.0 gf) at 0.00%, and non-opening (breakaway force >4.5 gf) or inadequate opening travel (<0.50 mm) at 0.00%. Only a very low 0.68% probability existed for reduced shutoff margin (net closing <2.0 gf), with worst-case (5th/95th percentile) leak volume in the most challenging 5% of parts estimated at <0.05 oz (≈1.4 grams) per 24 hours under combined vibration and head pressure. These outcomes confirm that the selected dimensions and tolerances provide robust seal integrity and consistent flow recovery, enabling the vent plug to maintain optimal battery fluid levels without overwatering while rivaling the performance margins of medical-grade micro-precision valves.

While the specific dimensions, tolerances, and performance parameters disclosed above—including the nominal spring rate of 2.23 gf/mm (±15%), free length of 11.7 mm (±0.30 mm), stack height of 10.80 mm (±0.12 mm), preload of 0.90 mm, hydrostatic assist of +0.60 gf, friction allowance of 0.50 gf, and actuator force of 4.5 gf—were optimized through the Monte Carlo analysis for the exemplary embodiment in typical industrial lead-acid battery applications (e.g., forklifts with approximately 30 inches of head pressure and representative vibration/shock profiles), it will be appreciated that other applications may present different operating conditions. Such conditions can include varying reservoir head pressures, alternative vibration and mechanical shock environments, different battery cell geometries or electrolyte properties, or modified flow-rate requirements. Accordingly, for any specific application, a similar Monte Carlo simulation (or equivalent statistical tolerance analysis) utilizing the corresponding application-specific parameters and tolerances should be performed to determine the optimum spring rate, preload, free length, stack height, actuator force, opening travel, and other critical dimensions of the diamond valve assembly. This tailored analysis ensures reliable no-weep shutoff under vibration while maintaining consistent flow recovery and proper fluid replenishment tailored to the particular operating environment.

The present invention provides substantial advantages over prior art battery watering systems. The automated battery watering system is entirely passive, requires no external power or active control, and travels with the battery assembly, thereby continuously and automatically maintaining optimal electrolyte levels in each battery cell whether the vehicle is operating, the batteries are being charged, or the system is at rest. Unlike conventional daisy-chain or float-valve systems that are prone to overwatering or under-watering due to vibration, temperature variations, and unequal water loss between cells, the inventive vent plugs independently regulate water delivery to each battery cell. This ensures consistent electrolyte levels across the entire battery array, significantly extending battery service life, improving overall performance and reliability, and eliminating the costly and error-prone manual maintenance required by traditional methods.

In particular, the vent plug embodiments illustrated in FIGS. 13-17B incorporate an advanced diamond valve assembly comprising a spring-biased diamond valve element, a buoyant float-linked actuator, and hydrostatically assisted sealing. This design delivers highly reliable, vibration-resistant shutoff characteristics that effectively prevent overwatering even under the significant mechanical shock and vibration typical of industrial vehicles such as forklifts. As validated by extensive Monte Carlo simulation across more than 100,000 production-tolerance iterations, the valve achieves statistically near-perfect reliability with negligible risk of weeping or leakage while preserving consistent flow recovery. The result is a robust, precision passive system that rivals medical-grade micro-valve performance yet retains the simplicity, cost-effectiveness, and self-contained nature of the overall watering system.

The claims appended hereto are meant to cover all modifications and changes within the scope and spirit of the present invention.

What is claimed is:

1. A vent plug for an automatic battery watering system, comprising:
a body configured to be received within a vent opening of a battery;
a water inlet in a head portion of the body;
a water chamber fluidly coupled to the water inlet;
a valve opening communicating with the water chamber;
a diamond valve element disposed in the water chamber and movable between a closed position sealing the valve opening and an open position allowing fluid flow therethrough;
a spring biasing the diamond valve element toward the closed position;
a buoyant float movably positioned in a lower portion of the vent plug; and
an actuator operatively coupled between the buoyant float and the diamond valve element, wherein a drop in battery electrolyte level causes the actuator to move the diamond valve element into the open position against the spring bias.

2. The vent plug of claim 1, wherein the diamond valve element comprises a top post extending through the valve opening and a main body having an upper conical portion configured to seat against the valve opening in the closed position.

3. The vent plug of claim 2, wherein the valve opening is chamfered to match the upper conical portion of the diamond valve element.

4. The vent plug of claim 1, wherein the diamond valve element further comprises a lower conical portion, the upper and lower conical portions meeting at a maximum diameter larger than an inner diameter of the spring.

5. The vent plug of claim 1, wherein the spring is preloaded when the diamond valve element is in the closed position.

6. The vent plug of claim 1, wherein the actuator is configured to move the diamond valve element downward by at least 0.5 mm to achieve the open position.

7. The vent plug of claim 1, further comprising a top wall of the water chamber, wherein the valve opening is formed in the top wall and the diamond valve element is biased upward against the top wall by the spring.

8. The vent plug of claim 1, wherein the buoyant float is mechanically linked to the actuator by at least one transfer arm and a transfer bar.

9. The vent plug of claim 1, wherein the vent plug is configured such that hydrostatic pressure from an elevated water reservoir assists in moving fluid through the valve opening when the diamond valve element is in the open position.

10. The vent plug of claim 1, wherein the diamond valve assembly is configured to exhibit a probability of non-closing of 0.00% and a probability of significant weep of 0.00% as determined by Monte Carlo simulation of production tolerances.

11. The vent plug of claim 1, wherein the actuator is operable to apply an opening force of approximately 4.5 gram-force to the diamond valve element.

12. The vent plug of claim 1, wherein the buoyant float is disposed in a float portion that extends below the skirt portion into the battery electrolyte when the vent plug is installed.

13. A vibration-resistant valve assembly for a battery watering vent plug, comprising:
a water chamber having an upper wall with a valve opening;
a diamond valve element having a top post extending through the valve opening;
a coil spring disposed within the water chamber and biasing the diamond valve element upward into sealing engagement with the valve opening; and
an actuator positioned above the water chamber and configured to selectively press downward on the top post of the diamond valve element to open the valve.

14. The valve assembly of claim 13, wherein the diamond valve element includes an upper conical sealing surface and a lower conical portion that engages an upper coil of the spring.

15. The valve assembly of claim 13, further comprising a buoyant float coupled to the actuator such that downward movement of the float causes the actuator to open the diamond valve element.

16. The valve assembly of claim 13, wherein the spring has a nominal spring rate of approximately 2.23 gram-force per millimeter.

17. The valve assembly of claim 13, wherein the assembly is configured so that a net closing force remains positive even in the worst-case 5th percentile of production tolerances as determined by Monte Carlo analysis.

18. An automatic battery watering system comprising:
a water reservoir;
a manifold fluidly coupled to the reservoir; and
a plurality of vent plugs fluidly coupled to the manifold, each vent plug configured for insertion into a respective battery cell vent opening, wherein each vent plug includes a diamond valve assembly having a spring-biased diamond valve element and a float-actuated mechanism configured to open the valve element only when an electrolyte level in the respective battery cell drops below a predetermined level.

19. The automatic battery watering system of claim 18, wherein each vent plug is configured to travel with the battery during vehicle operation, charging, and storage.

20. The automatic battery watering system of claim 18, further comprising an adjustable flow regulator between the water reservoir and the manifold.
